(19) United States
(12) Patent Application Publication
(10) Pub. No.: US 2023/0142706 A1
(43) Pub. Date: May 11, 2023

(54) VEHICLE CABIN AND RECHARGEABLE ENERGY STORAGE SYSTEM THERMAL MANAGEMENT SYSTEM

(71) Applicant: GM GLOBAL TECHNOLOGY OPERATIONS LLC, DETROIT, MI (US)

(72) Inventors: Srinivasa Rao Vaddiraju, Troy, MI (US); Jeffrey A. Bozeman, Rochester Hills, MI (US)

(21) Appl. No.: 17/521,985

(22) Filed: Nov. 9, 2021

(51) Int. Cl. B60H 1/00; B60H 1/32

(52) U.S. Cl. CPC B60H 1/00278; B60H 1/3227; B60H 1/32281; B60H 1/323; B60H 2001/00307

(57) ABSTRACT

A heating, ventilation and air conditioning (HVAC) system for a vehicle having a rechargeable energy storage system includes a refrigerant circuit having a flow of refrigerant circulated therethrough. The refrigerant circuit includes a compressor, an internal condenser, and a chiller heat exchanger. A coolant circuit is fluidly connected to the refrigerant circuit and has a flow of coolant circulated therethrough. The coolant circuit includes the internal condenser, a heater core, and a rechargeable energy storage system (RESS). The refrigerant circuit and the coolant circuit exchange thermal energy at the internal condenser. When operated in an HVAC operating mode, the HVAC system is configured to heat one or more of the heater core and the RESS with thermal energy generated at the compressor.

The subject disclosure relates to electric vehicles, and more precisely to heating of a cabin and a rechargeable energy storage system (RESS) of an electric vehicle.

A typical RESS, also known by the term a “Battery Pack” or other similar nomenclature has an optimal performance within a narrow temperature range. When operating conditions fall outside of this range at an upper end, the RESS is cooled by circulating a flow of coolant therethrough. When, on the other hand, the operating temperature is low, it is desired to heat the RESS to maintain performance. This heating is typically achieved via a separate cooling heater connected to the system. This separate cooling heater adds complexity to the system and increases energy usage of the system to provide heating of the RESS.

### SUMMARY

In one embodiment, a heating, ventilation and air conditioning (HVAC) system for a vehicle having a rechargeable energy storage system includes a refrigerant circuit having a flow of refrigerant circulated therethrough. The refrigerant circuit includes a compressor, an internal condenser, and a chiller heat exchanger. A coolant circuit is fluidly connected to the refrigerant circuit and has a flow of coolant circulated therethrough. The coolant circuit includes the internal condenser, a heater core, and a rechargeable energy storage system (RESS). The refrigerant circuit and the coolant circuit exchange thermal energy at the internal condenser. When operated in an HVAC operating mode, the HVAC system is configured to heat one or more of the heater core and the RESS with thermal energy generated at the compressor.

Additionally or alternatively, in this or other embodiments in the HVAC operating mode, the HVAC system is configured to heat one or more of the heater core and the RESS with only thermal energy generated at the compressor.

Additionally or alternatively, in this or other embodiments the flow of coolant is selectably flowed through the chiller heat exchanger to exchange thermal energy with the flow of coolant at the chiller heat exchanger.

Additionally or alternatively, in this or other embodiments the coolant circuit includes a chiller coolant bypass valve to selectably direct the flow of coolant along a chiller coolant bypass passage or through the chiller heat exchanger.

Additionally or alternatively, in this or other embodiments the HVAC operating mode is engaged when an ambient air temperature is less than −10 degrees Celsius.

Additionally or alternatively, in this or other embodiments a pump urges circulation of the flow of coolant through the coolant circuit.

Additionally or alternatively, in this or other embodiments the pump is located in the coolant circuit fluidly upstream of the internal condenser and the heater core, and fluidly downstream of the RESS.

Additionally or alternatively, in this or other embodiments the refrigerant circuit includes an outside heat exchanger fluidly connected to the internal condenser and the compressor.

Additionally or alternatively, in this or other embodiments when the HVAC system is operated in a heat pump mode, the flow of refrigerant is directed through the outside heat exchanger to absorb thermal energy from ambient air, bypassing the chiller heat exchanger.

Additionally or alternatively, in this or other embodiments an outside heat exchanger expansion valve is operable to selectably direct the flow of refrigerant through the outside heat exchanger.

Additionally or alternatively, in this or other embodiments the heat pump mode is engaged when an ambient air temperature is greater than −10 degrees Celsius.

In another embodiment, a method of heating a rechargeable energy storage system of a vehicle includes circulating a flow of refrigerant through a refrigerant circuit. The refrigerant circuit includes a compressor, an internal condenser, and a chiller heat exchanger. A flow of coolant is circulated through a coolant circuit. The coolant circuit includes the internal condenser, a heater core, and a rechargeable energy storage system (RESS). The flow of refrigerant is heated via operation of the compressor and thermal energy is exchanged between the flow of refrigerant and the flow of coolant at the internal heat condenser. One or more of the heater core and the RESS is heated via the flow of coolant.

Additionally or alternatively, in this or other embodiments in an HVAC operating mode heating one or more of the heater core and the RESS with only thermal energy generated at the compressor.

Additionally or alternatively, in this or other embodiments the HVAC operating mode is engaged when an ambient air temperature is less than −10 degrees Celsius.

Additionally or alternatively, in this or other embodiments the flow of coolant is selectably flowed through the chiller heat exchanger to exchange thermal energy with the flow of coolant at the chiller heat exchanger.

Additionally or alternatively, in this or other embodiments the coolant circuit includes a chiller coolant bypass valve to selectably direct the flow of coolant along a chiller coolant bypass passage or through the chiller heat exchanger.

Additionally or alternatively, in this or other embodiments an outside heat exchanger is located in the refrigerant circuit and is fluidly connected to the internal condenser and the compressor.

Additionally or alternatively, in this or other embodiments when in a heat pump mode, the flow of refrigerant is directed through the outside heat exchanger to absorb thermal energy from ambient air, bypassing the chiller heat exchanger.

Additionally or alternatively, in this or other embodiments the heat pump mode is engaged when an ambient air temperature is greater than −10 degrees Celsius.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic illustration of an embodiment of a heating, ventilation and air conditioning (HVAC) system;

FIG. 2 is a schematic illustration of an operating mode of an HVAC system;

FIG. 3 is a schematic illustration of another operating mode of an HVAC system;

FIG. 4 is a schematic illustration of yet another operating mode of an HVAC system;

FIG. 5 is a schematic illustration of still another operating mode of an HVAC system; and

FIG. 6 is a schematic illustration of another operating mode of an HVAC system.

### DETAILED DESCRIPTION

The following description is merely exemplary in nature and is not intended to limit the present disclosure, its application or uses. It should be understood that throughout the drawings, corresponding reference numerals indicate like or corresponding parts and features.

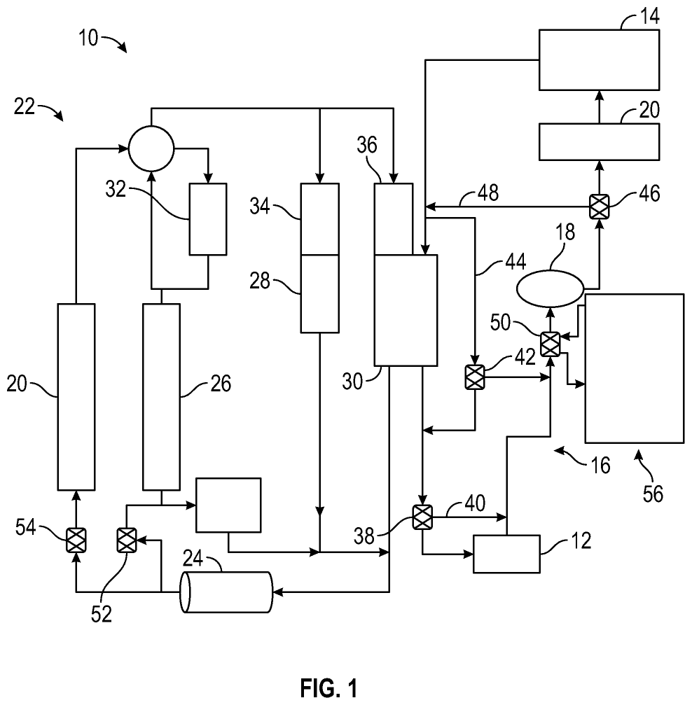

In accordance with an exemplary embodiment, an illustration of a heating, ventilation, and air conditioning (HVAC) system 10 for a vehicle is shown in FIG. 1. The vehicle includes a rechargeable energy storage system (RESS) 12, such as electric rechargeable traction batteries, electric double-layer capacitors or flywheel energy storage, and a heater core 14 as part of a coolant circuit 16, through which a flow of coolant is circulated. The heater core 14 is utilized for heating of a cabin of the vehicle. The flow of coolant is circulated through the coolant circuit 16 via a coolant pump 18, which in some embodiments is located between the RESS 12 and the heater core 14. An internal condenser 20 is located along the coolant circuit 16, in some embodiments between the coolant pump 18 and the heater core 14, and connects the coolant circuit 16 to a refrigerant circuit 22 arranged in parallel with the coolant circuit 16.

In the internal condenser 20, the flow of coolant of the coolant circuit 16 exchanges thermal energy with a flow of refrigerant from the refrigerant circuit 22. The refrigerant circuit 22 further includes a compressor 24 disposed fluidly upstream of the internal condenser 20, and three heat exchangers arranged in a fluidly parallel relationship downstream of the internal condenser 20. The three heat exchangers include an outside heat exchanger 26, an evaporator 28 and a chiller heat exchanger 30. Each heat exchanger has an associated expansion device located fluidly between the internal condenser 20 and the respective heat exchanger. The expansion devices are, respectively, an outside expansion valve 32, an evaporator expansion valve 34 and a chiller expansion valve 36. The chiller heat exchanger 30 is further connected to the coolant circuit 16 for thermal energy exchange between the flow of coolant and the flow of refrigerant at the chiller heat exchanger 30.

The HVAC system 10 is configured to operate in several operating modes, depending on the thermal demands of the RESS 12 and the heater core 14, as well as on ambient conditions and operating conditions of the vehicle, as will be discussed in greater detail below. To facilitate switching of operating modes, the HVAC system 10 includes a plurality of valves to selectably direct the flow of coolant and the flow of refrigerant along selected fluid pathways in the coolant circuit 16 and the refrigerant circuit 22. The coolant circuit 16 includes a RESS bypass valve 38 to selectably direct the flow of coolant along a RESS bypass passage 40 or through the RESS 12, a chiller coolant bypass valve 42 to selectably direct the flow of coolant along a chiller coolant bypass passage 44 or through the chiller heat exchanger 30, an internal condenser bypass valve 46 to selectably direct the flow of coolant along an internal condenser coolant bypass passage 48 or through the internal condenser 20, and a coolant four-way valve 50 upstream of the coolant pump 18. The other two connections on the coolant four-way valve 50 are connected to a power electronics coolant loop 56, which in some embodiments includes an associated low temperature radiator (not shown). The coolant four-way valve 50 can be operated in split mode where the coolant flow through the coolant circuit 16 and the power electronics coolant loop 56 is separated or in combined mode where the coolant flow through coolant circuit 16 and the power electronics coolant loop 56 is mixed. In addition to the aforementioned expansion valves, the refrigerant circuit 22 includes an outside heat exchanger valve 52 and an internal condenser refrigerant valve 54 to selectably direct the flow of refrigerant from the compressor 24 through the outside heat exchanger 26 or through the internal condenser 20.

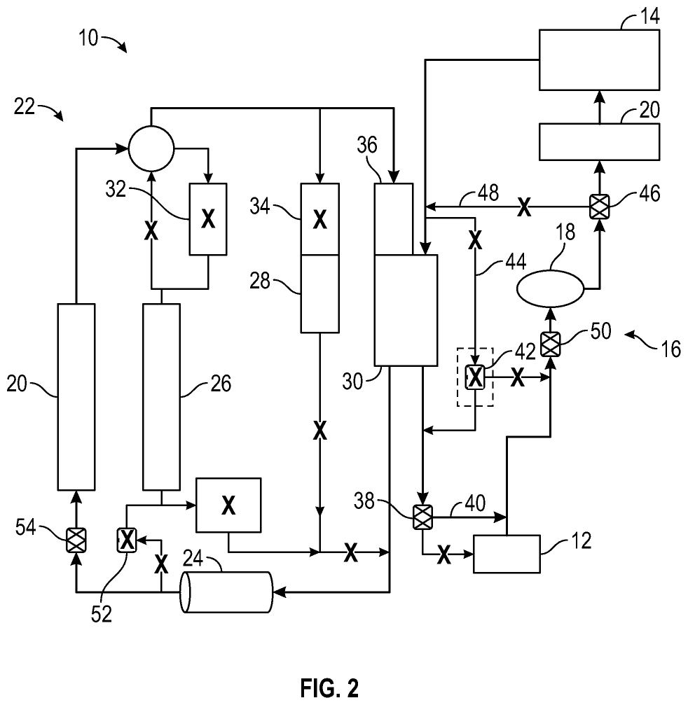

A first operating mode of the HVAC system 10 is illustrated in FIG. 2. This first mode is utilized, for example, when the cabin is requesting heating via the heater core 14 and a target discharge temperature of the heater core 14 is greater than 50 degrees Celsius. In the first mode, the internal condenser refrigerant valve 54 is open, the outside heat exchanger valve 52 is closed, the outside expansion valve 32, is closed, the evaporator expansion valve 34 is closed, and the chiller expansion valve 36 is opened. This directs the flow of refrigerant along the refrigerant circuit 22 through the compressor 24, the internal condenser 20, the chiller expansion valve 36, the chiller heat exchanger 30 and back to the compressor 24, bypassing the outside heat exchanger 26 and the evaporator 28. In the coolant circuit 16, the internal condenser bypass valve 46 is set to direct the coolant flow through the internal condenser 20, and the chiller coolant bypass valve 42 is set to direct the flow of coolant through the chiller heat exchanger 30, while the RESS bypass valve 38 is set to direct the flow of coolant along the RESS bypass passage 40. Thus, the flow of coolant is directed along the coolant circuit 16 from the pump 46 through the internal condenser 20, the heater core 14 and the chiller heat exchanger 30. The RESS bypass valve 38 directs the flow of coolant along the RESS bypass passage 40 thus bypassing the RESS 12 before being directed back to the pump 18. The cabin is thus heated by the heater core 14 by the heat of compression from the compressor 24, without the introduction of outside ambient air for heat removal from the RESS 12.

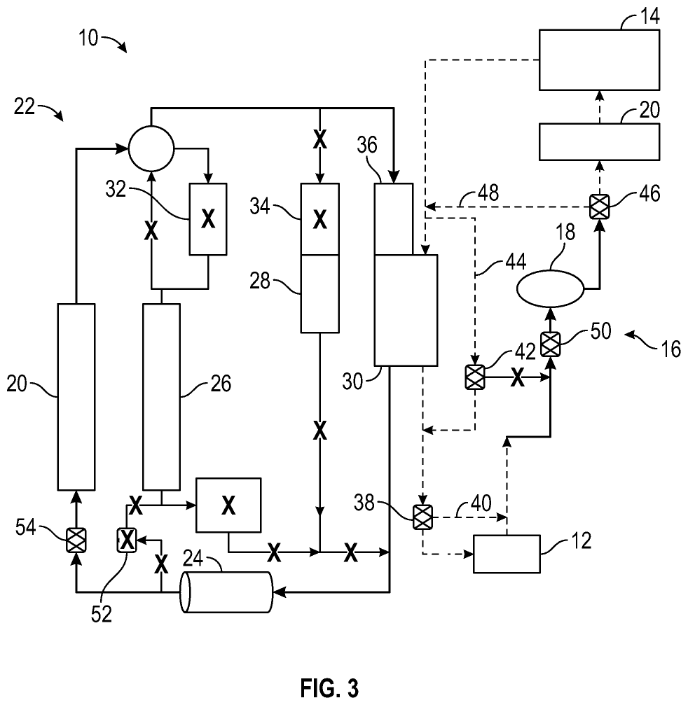

If, on the other hand, the target discharge temperature of the heater core 14 not greater than 50 degrees Celsius, the HVAC system 10 is operated in a second mode where the valves 38, 42 and 46 are modulated to provide the desired amount of heating to the heater core 14, as illustrated in FIG. 3. In the second mode, the chiller coolant bypass valve 42 is selectably or partially opened to modulate flow of coolant through the chiller heat exchanger 30 and the chiller coolant bypass passage 44. Similarly, the RESS bypass valve 38 is partially or selectably opened to modulate the flow of coolant along the RESS bypass passage 40 and through the RESS 12. The internal condenser bypass valve 46 is similarly selectably or partially opened to modulate the flow of coolant along the internal condenser coolant bypass passage 48 or through the internal condenser 20. This modulation of the valves 38, 42 and 46 provides the desired amount of heating to the heater core 14.

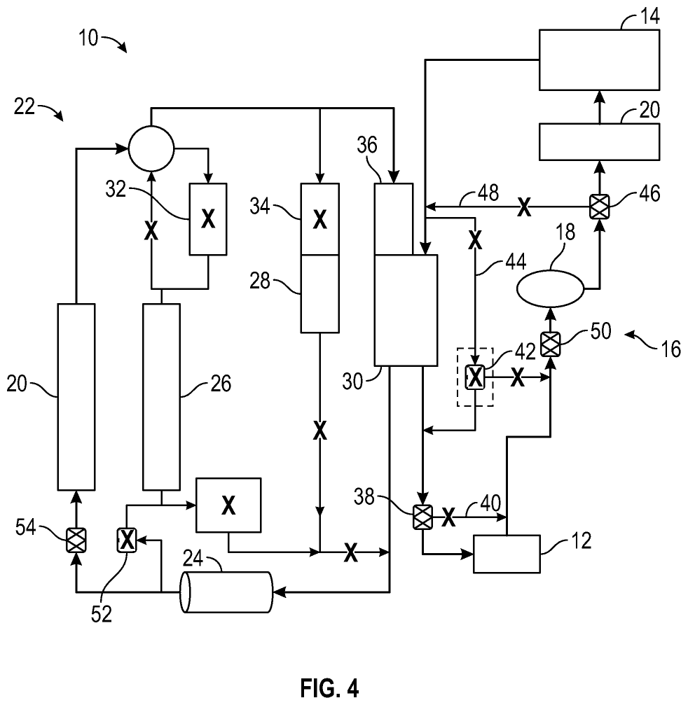

Referring now to FIG. 4, in a third mode the internal condenser bypass valve 46 is set to direct the coolant flow through the internal condenser 20, and the chiller coolant bypass valve 42 is set to direct the flow of coolant through the chiller heat exchanger 30, while the RESS bypass valve 38 is set to direct the flow of coolant through the RESS 12. Thus, the flow of coolant is directed along the coolant circuit 16 from the pump 18 through the internal condenser 20, the heater core 14 and the chiller heat exchanger 30. The RESS bypass valve 38 directs the flow of coolant through the RESS 12 before being directed back to the pump 18. The cabin is thus heated by the heater core 14, and the RESS 12 is heated by the heat of compression from the compressor 24, without the introduction of outside ambient air for heat removal from the RESS 12.

The valve and flow configuration shown in FIG. 4 may also be utilized to operate the HVAC system 10 in a fourth mode, where waste heat from the RESS 12 is utilized to further provide heat to the heater core 14 for cabin heating. This mode may be utilized when the ambient temperature is very low, for example, less than −10 degrees Celsius and the temperature of the RESS 12 is relatively high, such as greater than 10 degrees Celsius.

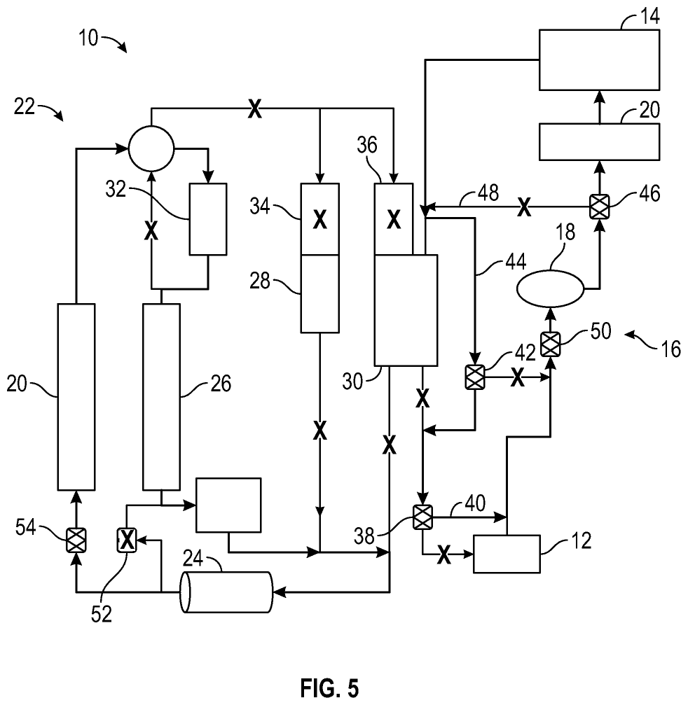

In some embodiments, such as when the ambient temperature is greater than −10 degrees Celsius, the HVAC system 10 operates as a heat pump, drawing heat from outside air via the outside heat exchanger 26. Referring now to FIG. 5, when the ambient temperature is greater than −10 degrees Celsius, and the target discharge temperature of the heater core 14 is greater than 50 degrees Celsius, the HVAC system 10 operates in a fifth mode. In this fifth mode, the internal condenser refrigerant valve 54 is opened and the outside heat exchanger refrigerant valve 52 is closed. The outside heat exchanger expansion valve 32 is opened, and both the evaporator expansion valve 34 and the chiller expansion valve 36 are closed. Thus, in the refrigerant circuit 22 the refrigerant flows from the compressor 24 through the internal condenser 20 and then through the outside heat exchanger 26 which acts as an evaporator by exchanging thermal energy with outside air. From the outside heat exchanger 26, the refrigerant returns to the compressor 24. In the coolant circuit 16, the coolant valves 38, 42, 46 and 50 are set to direct the flow of coolant from the pump 18 and through the internal condenser 20 and then the heater core 14. The flow of coolant then bypasses the chiller heat exchanger 30 and the RESS 12 as directed by valves 38 and 42. From the RESS bypass passage 40, the flow of coolant then returns to the pump 18.

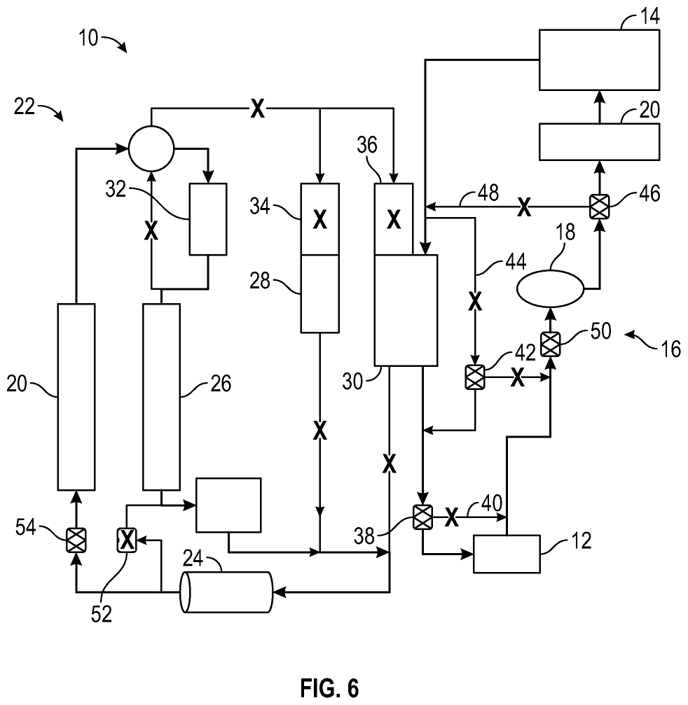

In another embodiment, illustrated in FIG. 6, the HVAC system 10 operates in a sixth mode, where the RESS 12 requires heating. In this mode, in the coolant circuit 16, the coolant valves 38, 42, 46 and 50 are set to direct the flow of coolant from the pump 18 and through the internal condenser 20 and then the heater core 14. The flow of coolant then flows through the chiller heat exchanger 30 and the RESS 12 as directed by valves 38 and 42. From the RESS 12, the flow of coolant then returns to the pump 18.

The HVAC system 10 described herein utilizes the refrigerant circuit 22 to heat the cabin via the heater core 14 and the RESS 12 by utilizing only compressor 24 power, and not utilizing a typical coolant heater in cold weather (less than −10 degrees Celsius). This is accomplished by routing the flow of coolant in the coolant circuit 16 through the internal condenser 20 and the heater core 14. The system 10 can also be operated to pull heat from ambient when the ambient temperature is higher, thus saving energy usage.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A heating, ventilation and air conditioning (HVAC) system for a vehicle having a rechargeable energy storage system, comprising:
a refrigerant circuit having a flow of refrigerant circulated therethrough, the refrigerant circuit including:
a compressor;
an internal condenser; and
a chiller heat exchanger; and
a coolant circuit fluidly connected to the refrigerant circuit and having a flow of coolant circulated therethrough, the coolant circuit including:
the internal condenser;
a heater core; and
a rechargeable energy storage system (RESS);
wherein the refrigerant circuit and the coolant circuit exchange thermal energy at the internal condenser; and
wherein when operated in an HVAC operating mode, the HVAC system is configured to heat one or more of the heater core and the RESS with thermal energy generated at the compressor.

2. The HVAC system of claim 1, wherein in the HVAC operating mode, the HVAC system is configured to heat one or more of the heater core and the RESS with only thermal energy generated at the compressor.

3. The HVAC system of claim 1, wherein the flow of coolant is selectably flowed through the chiller heat exchanger to exchange thermal energy with the flow of coolant at the chiller heat exchanger.

4. The HVAC system of claim 3, wherein the coolant circuit includes a chiller coolant bypass valve to selectably direct the flow of coolant along a chiller coolant bypass passage or through the chiller heat exchanger.

5. The HVAC system of claim 1, wherein the HVAC operating mode is engaged when an ambient air temperature is less than −10 degrees Celsius.

6. The HVAC system of claim 1, further comprising a pump to urge circulation of the flow of coolant through the coolant circuit.

7. The HVAC system of claim 6, wherein the pump is located in the coolant circuit fluidly upstream of the internal condenser and the heater core, and fluidly downstream of the RESS.

8. The HVAC system of claim 1, the refrigerant circuit further comprising an outside heat exchanger fluidly connected to the internal condenser and the compressor.

9. The HVAC system of claim 8, wherein when the HVAC system is operated in a heat pump mode, the flow of refrigerant is directed through the outside heat exchanger to absorb thermal energy from ambient air, bypassing the chiller heat exchanger.

10. The HVAC system of claim 9, further comprising an outside heat exchanger expansion valve operable to selectably direct the flow of refrigerant through the outside heat exchanger.

11. The HVAC system of claim 9, wherein the heat pump mode is engaged when an ambient air temperature is greater than −10 degrees Celsius.

12. A method of heating a rechargeable energy storage system of a vehicle comprising:
circulating a flow of refrigerant through a refrigerant circuit, the refrigerant circuit including:
a compressor;
an internal condenser; and
a chiller heat exchanger;
circulating a flow of coolant through a coolant circuit, the coolant circuit including:
the internal condenser;
a heater core; and
a rechargeable energy storage system (RESS);
heating the flow of refrigerant via operation of the compressor;
exchanging thermal energy between the flow of refrigerant and the flow of coolant at the internal heat condenser; and
heating one or more of the heater core and the RESS via the flow of coolant.

13. The method of claim 12, further comprising in an HVAC operating mode heating one or more of the heater core and the RESS with only thermal energy generated at the compressor.

14. The method of claim 13, wherein the HVAC operating mode is engaged when an ambient air temperature is less than −10 degrees Celsius.

15. The method of claim 12, wherein the flow of coolant is selectably flowed through the chiller heat exchanger to exchange thermal energy with the flow of coolant at the chiller heat exchanger.

16. The method of claim 15, wherein the coolant circuit includes a chiller coolant bypass valve to selectably direct the flow of coolant along a chiller coolant bypass passage or through the chiller heat exchanger.

17. The method of claim 12, wherein an outside heat exchanger is disposed in the refrigerant circuit and is fluidly connected to the internal condenser and the compressor.

18. The method of claim 17, wherein when in a heat pump mode, the flow of refrigerant is directed through the outside heat exchanger to absorb thermal energy from ambient air, bypassing the chiller heat exchanger.

19. The method of claim 18, wherein the heat pump mode is engaged when an ambient air temperature is greater than −10 degrees Celsius.
